(19) United States
(12) Patent Application Publication
(10) Pub. No.: US 2024/0380169 A1
(43) Pub. Date: Nov. 14, 2024

(54) CABLE PROCESSING MACHINE AND METHOD OF OPERATING A CABLE PROCESSING MACHINE

(71) Applicant: komax Holding AG, Dierikon (CH)

(72) Inventor: Bruno WEBER, Ballwil (CH)

(73) Assignee: komax Holding AG, Dierikon (CH)

(21) Appl. No.: 18/645,518

(22) Filed: Apr. 25, 2024

(30) Foreign Application Priority Data
May 9, 2023 (EP) 23172297.6

(51) Int. Cl. H01R 43/052

(52) U.S. Cl. CPC H01R 43/052

(57) ABSTRACT

A cable processing machine includes a crimping press that includes a process location at which a crimping operation of a crimp contact located in the press can be performed on a cable end region; a cable feeding device having a cable holder configured to grip the cable end region; and a cable tip sensor fixed to the press at a detection location different from the process location and having a known positional relationship to the process location. The sensor is configured to detect a cable tip at the cable end region in a sensor plane of the sensor. The cable feeding device is configured to move the cable end region to the detection location and there to advance the cable tip towards the sensor plane until the cable tip is detected in the sensor plane, and thereafter moves the cable end region to the process location of the press.

### CROSS REFERENCE TO RELATED APPLICATIONS

Applicant claims priority under 35 U.S.C. § 119 of European Application No. 23172297.6 filed May 9, 2023, the disclosure of which is incorporated by reference.

### BACKGROUND OF THE INVENTION

### 1. Field of the Invention

The present disclosure relates to a cable processing machine and a method of operating a cable processing machine.

### 2. Description of the Related Art

For the quality of a crimp connection, it is desirable that a cable tip on a cable end which is inserted into a crimp contact to be crimped is aligned relatively precisely with the crimp contact or within the crimp contact. In particular, it is desirable that the cable tip is positioned as precisely as possible in the longitudinal direction (so-called insertion depth). Possible deviations to be tolerated in the longitudinal direction are in the range of 0.1 mm, for example.

Known from EP 3 247 007 B1 is adapter plate alignment gauge system for holding a crimping tool and for aligning the crimping tool in a fixedly predetermined position relative to the alignment gauge. An adapter plate of the known system is moved and fixed by hand so that the cable tip is positioned in the crimping tool with some accuracy.

Known from WO 2021 148 981 A1 is a cable machine with a cable processing station, wherein an imaging sensor device is provided for detecting an image of a cable end of an inserted cable in order to be able to perform image-recognition-aided positioning of the cable end.

### Technical Problem

It has been shown that the insertion depth not only varies to a certain extent during ongoing production, but that there is also a time-dependent change in position (drift). It is assumed that this drift is due to heat-related expansion of the machine frame.

With the adapter plate alignment gauge system known from EP 3 247 007 B1, such a drift cannot be taken into account, since the known adapter plate alignment gauge system is not suitable for detecting and correcting changes in the spatial position of the cable tip during production operation.

The technology known from WO 2021 148 981 A1 is difficult to implement in practice since mounting the optical sensor and the associated complex lighting sufficiently close to a position that ensures reliable detection can only be done at great expense. Image evaluation in the course of image-recognition-aided positioning is also computationally intensive and time-consuming and requires additional high-performance hardware.

It is therefore an object of the present disclosure to provide a cable processing machine or a method for operating a cable processing machine, wherein a reliable alignment of the cable end in the crimp contact, in particular longitudinal alignment, is ensured even under changing environmental conditions.

### SUMMARY OF THE INVENTION

A cable processing machine according to one aspect of the invention and a method for operating a cable processing machine according to another aspect of the invention are provided.

According to one aspect, a cable processing machine comprises a crimping press, a cable feeding device and a cable tip sensor. The crimping press comprises a process location at which a crimping operation of a crimp contact, which is located in the crimping press-for example in a crimping tool or crimping tool part of the crimping press-can be performed on an end portion of a cable. The cable feeding device comprises a cable holder for holding the end region of the cable. For example, the cable holder is designed as a cable gripper for gripping the cable. In particular, the end region of the cable comprises a region of the cable in which the longitudinal axis of the cable runs substantially within a plane. The cable tip sensor is fixed at a detection location, with the detection location being different from the process location. The detection location has a known positional relationship to the process location, with the positional relationship comprising, for example, a direction and a distance, and therefore represents a vectorial quantity. The cable tip sensor is configured such that it detects the presence or absence of a cable tip, which is located at the end region of the cable, in a sensor plane of the cable tip sensor. The cable feeding device is configured such that it moves the end region of the cable to the detection location and moves the cable tip in the direction of the sensor plane of the cable tip sensor until the cable tip is detected in the sensor plane, and thereafter moves the end region of the cable to the process location of the crimping press. The movement of the cable tip in the direction of the sensor plane comprises, in particular, a substantially linear movement along the longitudinal axis of the end region of the cable.

The process location comprises, for example, a process point or a process region consisting of multiple points, wherein a crimping tool acts on the crimp contact at the process location so that the crimp contact is fastened (crimped) to the cable end. The setup location comprises, for example, a setup point or a setup region consisting of multiple points, wherein an initial position of the cable tip of the cable end is established or ensured at the setup location for a subsequent crimping process.

By means of the known positional relationship between the process location and the setup location it is possible, for example, to determine or correct a target value for the movement to the process location.

According to one aspect, a method for operating a cable processing machine configured as described herein comprises moving, in particular pivoting, the end region of the cable to the detection location, moving, in particular advancing, the cable tip in the direction of the sensor plane of the cable tip sensor, and moving, in particular pivoting, the end region of the cable to the process location.

Advantageous further developments are discussed below.

In some embodiments, the cable feeding device comprises a pivot arm. Moving to the detection location and moving to the process location each comprises, for example, pivoting by means of the pivot arm. However, the disclosure is not limited to cable processing machines of the pivot arm type. For example, a transfer-type cable processing machine can also be used. Moving to the detection location and moving to the process location in the case of a transfer-type cable processing machine comprises, for example, a linear movement perpendicular to the cable axis.

In some embodiments, the crimping tool comprises a stationary crimping tool part and a movable crimping tool part. In other words, the crimping tool can be of the split type. However, the disclosure is not limited to split-type crimping tools. For example, a one-piece crimping tool or crimping press can also be provided.

In some embodiments, the cable tip sensor can be integrated in a waste channel of the cable processing machine. A waste channel is used to accommodate crimp contact waste pieces, such as contact strip carrier pieces, which accumulate during a crimping process. Here, for example, in a pivot-type cable processing machine, the end region of the cable provided with the crimp contact can be pivoted away above the cable tip sensor after the crimping process.

In some embodiments, the cable tip sensor comprises an insertion contour which is designed to guide an inserted cable tip towards the sensor plane. For example, the insertion contour is funnel-shaped so that the cable tip safely reaches the sensor plane, for example when the cable is slightly bent at the end region. This also makes it easy to find out if an end region is bent too much, since no detection takes place in this case.

In some embodiments, the cable tip sensor comprises a contact surface in the sensor plane. The contact surface is configured for capacitance or inductance measurement, for example by means of suitable measurement electronics that is connected to the electrically conductive contact surface. In particular, the cable tip sensor uses the contact surface to detect a change in capacitance or inductance that comes along with contacting the contact surface of a cable tip. When the change in capacitance or inductance is detected, the cable tip has reached the sensor plane.

Alternatively, in some embodiments, the cable tip sensor comprises an optical detector in the sensor plane for detecting the cable tip, for example and without limitation, a line sensor or a light barrier. When the cable tip is detected, it has reached the sensor plane.

In some embodiments, the method further comprises, namely prior to moving to the detection location, a calibration process, wherein the calibration process comprises mounting a setup gauge at the process location, mounting a sensing mandrel on the cable holder of the cable feeding device, moving the sensing mandrel to determine a feed end point at the process location, moving the sensing mandrel to determine an angle of the cable feeding device at the process location, and moving the sensing mandrel to determine a feed end point at the detection location. The setup gauge comprises a sensing contour with a contour contact surface and with contour side surfaces. To determine the feed end point at the process location, the sensing mandrel is moved, in particular advanced, in the direction of the contour contact surface until it reaches the contact surfaces, in particular comes into contact with it. To determine the angle of the cable feeding device at the process location, the sensing mandrel is moved in the direction of each contour side surface until it reaches, in particular comes into contact with, the respective contour side surface. To determine the feed end point at the detection location, the sensing mandrel is moved, in particular advanced, in the direction of the sensor plane until it reaches the sensor plane, in particular comes into contact with it.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a perspective view of a cable processing machine according to an embodiment;

FIG. 2 shows a plan view of a crimp contact with the end region of a cable inserted;

FIG. 3 shows a perspective view of a section of the cable processing machine of FIG. 1;

FIG. 4 shows a top view of a section of the cable processing machine of FIG. 1;

FIG. 5 shows a perspective view of a section of the cable processing machine of FIG. 1;

FIG. 6 shows a perspective view of a section of the cable processing machine of FIG. 1 during a calibration process; and

FIG. 7 shows a top view of a section of the cable processing machine of FIG. 1 during the calibration process.

### DETAILED DESCRIPTION OF PREFERRED EMBODIMENTS

The drawings are exemplary and not to scale; identical or similarly acting features are provided with identical reference signs in the drawings, and their repeated description is omitted. Features in the embodiments can be suitably combined or omitted as appropriate.

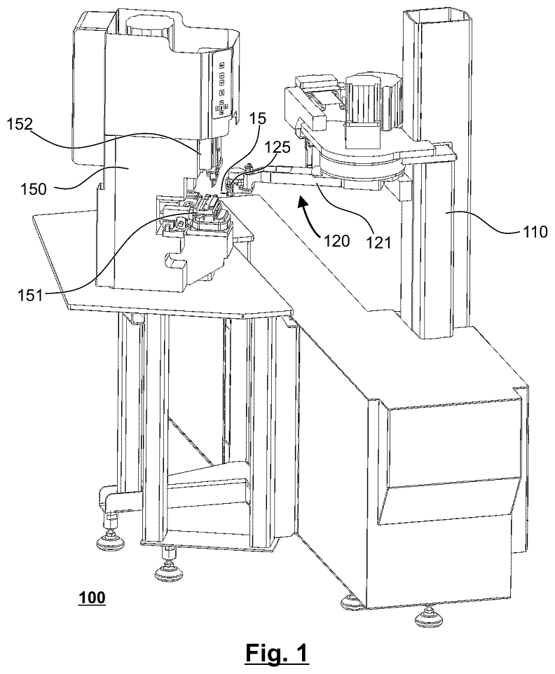

FIG. 1 shows a perspective view of a cable processing machine 100. Fastened to a machine frame 110 is a cable feeding device 120 which in the present case is designed, by way of example and without being restrictive, as a pivot arm 121. Fastened to the pivot arm 121 is a cable holder 125 which, in the present case is designed, by way of example and without being restrictive, as a cable gripper. The cable holder 125 holds an inserted cable 10 at the end region 11 thereof. At the end region 11, a cable tip 15 forms the termination of the cable 10. The cable processing machine 100 further comprises a crimping press 150, which is exemplarily provided here as a two-part press with a stationary (lower) tool part 151 and a movable (upper) tool part 152. The movable tool part 152 can be moved towards the stationary tool part 151 by means of the crimping press 150 in order to fasten (crimp) a crimp contact to the end region 11 of the cable 10.

FIG. 2 shows an enlarged view of the cable end 11 of the cable 10, which is inserted into a crimp contact 20. The crimp zone 21 is used for connection (crimping) by pressing between the cable end 11 and the crimp contact 20. The cable tip 15, which forms the termination of the cable end 11, is located at an insertion depth T relative to the crimp zone 21. For a usably crimped crimp contact 20, an accuracy of the insertion depth T of 0.1 mm or less is required, for example.

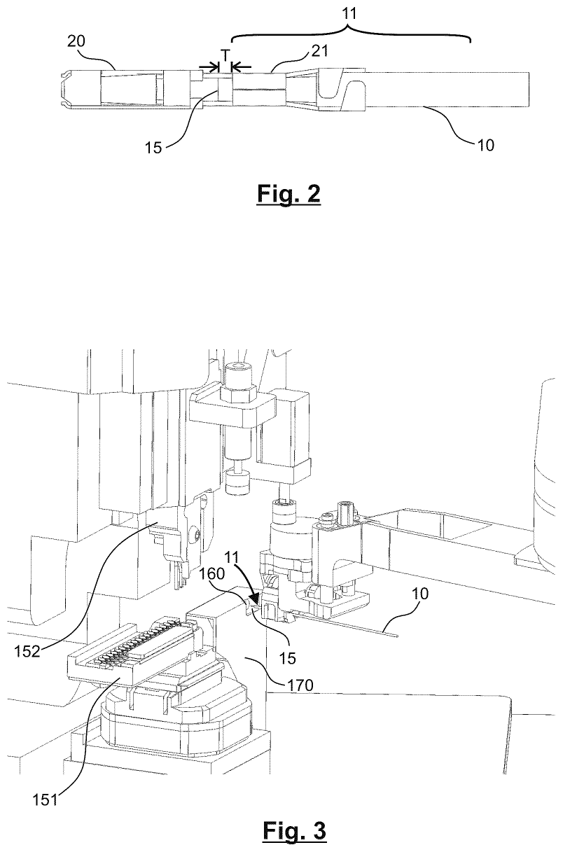

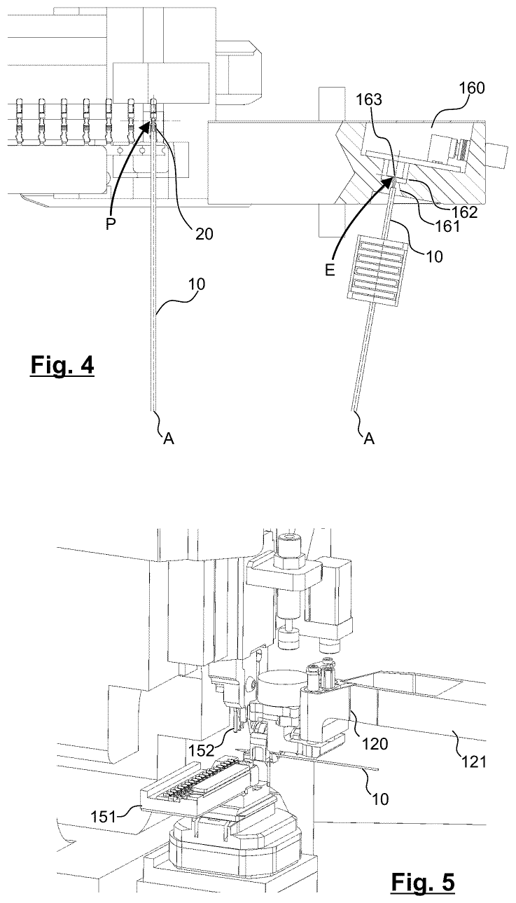

FIG. 3 shows a perspective enlarged view of a part of the cable processing machine 100 of FIG. 1. As an example and without being restrictive, a cable tip sensor 160 is mounted on the crimping press 150 on a waste channel 170 of the crimping press 150 in the example shown. As can be seen from the plan view in FIG. 4, the cable tip sensor comprises an insertion contour 161, here funnel-shaped as an example, and a sensor plane 162, here a contact surface 163 as an example. A detection location E, for example a detection point, is given by the intersection of the longitudinal cable axis A of the cable 10 with the sensor plane 162. The cable tip 15 is positioned at the detection point E by moving the cable 10 or the end region 11 thereof towards the sensor plane 162 by means of the cable holder 125 until the cable tip sensor 160 detects that the sensor plane 162 has been reached, thus, in this example, detects that the contact surface 163 is contacted by the cable tip 15. Such a detection can take place, for example, by detecting a change in inductance or capacitance. The cable tip sensor 160 is appropriately sensitive, so that reaching the sensor plane 162 is reliably detected substantially without any deformation of the cable tip 15. Instead of the contact surface 163, an optical detector, for example a line sensor or a light barrier (not shown), can also be used.

In the example shown, the insertion contour 161 is funnel-shaped, without being limited thereto. The insertion contour 161 also allows a slightly bent end region 11 of the cable 10 to be safely guided to the sensor plane 162. If the cable 10 is bent too much at the end region 11, this can be recognized, as no detection takes place in this case.

FIG. 4 also shows the cable 10 in a process position in which crimping takes place. The cable tip 15 is located at the process location P, for example a process point. The positional relationship between process location P and detection location E (the vector from detection location E to process location P) is known. As a result, the process location P can be approached reliably and precisely after the cable tip 15 has been detected at the detection location E. In the case of the illustrated pivot-type cable processing machine 100, the cable holder 125 performs a pivoting movement and a linear movement in the cable direction. In the case of a transfer-type cable processing machine (not shown), the associated cable holder would perform a linear movement substantially perpendicular to the longitudinal cable axis A instead of the pivoting movement.

In order to control the position of the cable holder 125, in the case of a pivot-type cable processing machine 100, for example, a sensor motor with an encoder is provided on the pivot arm 121 in each case, from which the position of the cable holder 125 and the necessary trajectories can be calculated. The process location P can vary depending on the type of crimp contact 20; however, this is known to a machine controller used to execute the movement processes.

While FIG. 3, as described above, shows the cable end 11 of the cable 10 in the position at the detection location E, the perspective view from FIG. 5 shows the cable end 11 of the cable 10 in the position at the process location P.

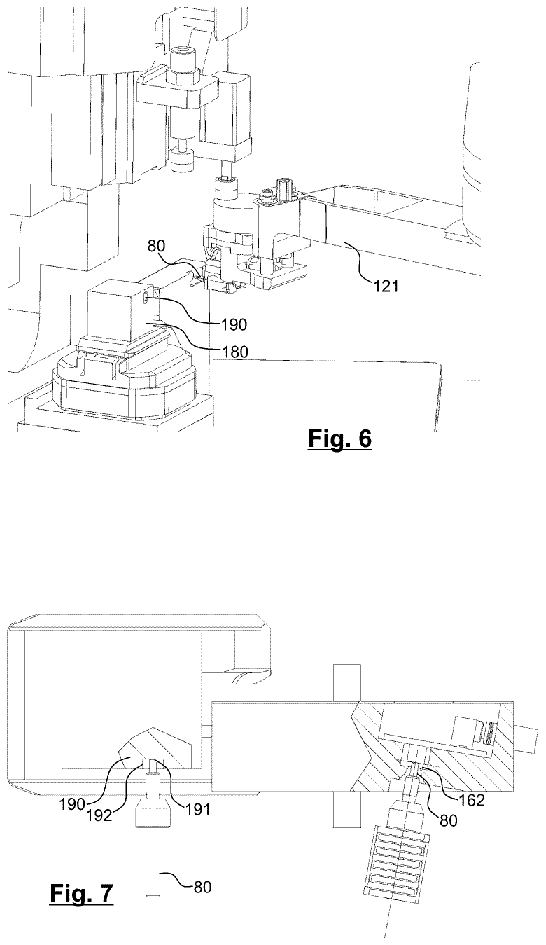

FIG. 6 shows a section of the cable processing machine 100 analogous to FIG. 3, but with the cable end 11 replaced by a sensing mandrel 80 for a setup or calibration process and the stationary part of the crimping tool 151 replaced by a setup gauge 180. This configuration can be used to set up the cable tip sensor 160 and determine the position of the crimping press 150 on the machine 100, thus the process position. The setup gauge, which is inserted into the tool holder of the crimping press 150 instead of the stationary part of the crimping tool 151, comprises a groove-shaped sensing contour 190. The sensing contour 190 comprises a contour contact surface in the direction of the longitudinal cable axis A of a cable fictitiously inserted there and two lateral contact surfaces (contour side surfaces) 192. The sensing mandrel 80 is mounted on the cable holder 125, which acts like a cable tip 15 on the cable tip sensor 160.

The sensing mandrel 80 is inserted into the sensing contour 190 and moved by means of the cable holder 125 in the direction of the longitudinal cable axis A of the fictitiously inserted cable until it reaches the contour contact surface 191. This contact is suitably detected, for example by detecting the motor current and/or detecting the torque of a servomotor which is responsible for the longitudinal movement of the pivot arm. When the contact is detected, the feed end point at the process location P is determined.

The sensing mandrel 80 is also moved in each case until the contour side surfaces 192 are reached; the contact with the respective contour side surface 192 is detected, for example by detecting the motor current of a pivot motor of the pivot arm 121 responsible for the pivotal movement; and when the contact is detected, the angle of the cable feeding device 120 at the process location P is determined.

After the process location has been determined in this manner, the cable tip sensor 160 is triggered with the sensing mandrel 80; the detection location E is thus determined.

Although only a few embodiments of the present invention have been shown and described, it is to be understood that many changes and modifications may be made thereunto without departing from the spirit and scope of the invention.

What is claimed is:

1. A cable processing machine (100) comprising:
a crimping press (150), wherein the crimping press (150) comprises a process location (P) at which a crimping operation of a crimp contact (20) located in the crimping press (150) can be performed on an end region (11) of a cable (10);
a cable feeding device (120) having a cable holder (125), wherein the cable holder (125) is configured to grip the end region (11) of the cable (10); and
a cable tip sensor (160) fixed to the crimping press (150) at a detection location (E), wherein the detection location (E) is different from the process location (P) and has a known positional relationship to the process location (P), and wherein the cable tip sensor (160) is configured to detect a cable tip (15) at the end region (11) of the cable (10) in a sensor plane (162) of the cable tip sensor (160);
wherein the cable feeding device (120) is configured such that it moves the end region (11) of the cable (10) to the detection location (E) and there advances the cable tip (15) towards the sensor plane (162) of the cable tip sensor (160) until the cable tip (15) is detected in the sensor plane (162), and thereafter moves the end region (11) of the cable (10) to the process location (P) of the crimping press (150).

2. The cable processing machine (100) according to claim 1, wherein the cable feeding device (120) comprises a pivot arm (121).

3. The cable processing machine (100) according to claim 2, wherein moving to the detection location (E) and moving to the process location (P) each comprise pivoting the end region (11) of the cable (10) by means of the pivot arm (121).

4. The cable processing machine (100) according to claim 1, wherein the crimping press (150) comprises a stationary crimping tool part (151) and a movable crimping tool part (152).

5. The cable processing machine (100) according to claim 1, wherein the cable tip sensor (160) is integrated in a waste channel (170), wherein the waste channel (170) is configured to accommodate crimp contact waste pieces produced during a crimping operation.

6. The cable processing machine (100) according to claim 1, wherein the cable tip sensor (160) has an insertion contour (161) designed for guiding an inserted cable tip (15) towards the sensor plane (162).

7. The cable processing machine (100) according to claim 1, wherein the cable tip sensor (160) comprises a contact surface (163) in the sensor plane (162) for measuring a capacitance or an inductance.

8. The cable processing machine (100) according to claim 1, wherein the cable tip sensor (160) comprises an optical detector in the sensor plane (162) for detecting the cable tip (15).

9. A method for operating a cable processing machine (100) according to claim 1, wherein the method comprises:
moving, in particular pivoting, the end region (11) of the cable (10) to the detection location (E);
at the detection location (E): advancing the cable tip (15) in the direction of the sensor plane (162) of the cable tip sensor (160); and
moving, in particular pivoting, the end region (11) of the cable (10) to the process location (P).

10. The method according to claim 9, additionally comprising, before moving to the detection location:
mounting a setup gauge (180), which has a sensing contour (190) with a contour contact surface (191) and contour side surfaces (192), at the process location (P);
mounting a sensing mandrel (80) on the cable holder (125) of the cable feeding device (120);
moving, by means of the cable feeding device (120), the sensing mandrel (80) until it reaches the contour contact surface (191), to determine a feed end point at the process location (P);
moving, by means of the cable feeding device (120), the sensing mandrel (80) until the contour side surfaces (192) are reached, to determine an angle of the cable feeding device (120) at the process location (P); and
moving, by means of the cable feeding device (120), the sensing mandrel (80) to the detection location (E), and moving, in particular advancing, the sensing mandrel in the direction of the sensor plane (162) of the cable tip sensor (160) to determine a feed end point at the detection location (E).
